(19) United States
(12) Patent Application Publication
(10) Pub. No.: US 2024/0261749 A1
(43) Pub. Date: Aug. 8, 2024

(54) HEAT EXCHANGE REACTOR WITH REDUCED METAL DUSTING

(71) Applicant: Topsoe A/S, Kgs. Lyngby (DK)

(72) Inventors: Peter Mølgaard MORTENSEN, Roskilde (DK); Kim AASBERG-PETERSEN, Allerød (DK)

(73) Assignee: Topsoe A/S, Kgs. Lyngby (DK)

(21) Appl. No.: 18/562,989

(22) PCT Filed: Jun. 2, 2022
(86) PCT No.: PCT/EP2022/065067

§ 371 Date: Nov. 21, 2023

(30) Foreign Application Priority Data
Jun. 3, 2021 (EP) 21177657.0

(51) Int. Cl. B01J 8/04; C01B 3/14

(52) U.S. Cl. CPC B01J 8/0496; B01J 8/0469; C01B 3/14; B01J 2208/00212; B01J 2208/00309; B01J 2208/00504; B01J 2208/0053; C01B 2203/0233; C01B 2203/0833; C01B 2203/085; C01B 2203/148; C01B 2203/1623

(57) ABSTRACT

The present technology relates to a heat exchange reactor (HER) system comprising a first gas feed and a heat exchange reactor, HER. The HER has two reaction zones; a first reaction zone (I) arranged to carry out an overall exothermic reaction of the first gas feed, and a second reaction zone (II) arranged to carry out an overall endothermic reaction of gas from said first reaction zone (I).

### TECHNICAL FIELD

The present technology relates to a process for converting a first gas feed comprising CO₂ and H₂ to a synthesis gas (syngas) stream, via a CO₂ shift reaction, in a heat exchange reactor (HER). The HER has two reaction zones; a first reaction zone arranged to carry out an overall exothermic reaction of the first gas feed, and a second reaction zone arranged to carry out an overall endothermic reaction of gas from said first reaction zone (I).

### BACKGROUND

Production of CO from CO₂ can be carried out by means of the reverse water gas shift reaction according to:

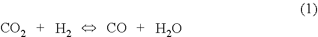

This is an endothermic reaction and consequently requires an energy input to proceed. Few industrial realizations of the technology actually exist, but on paper the reaction can be facilitated in a steam methane reformer (SMR)-like configuration where heat is supplied by external heating and the reaction is facilitated inside heated reactor zones or reactor tubes.

However, external heating typically means combustion of a hydrocarbon fuel and consequently often has an associated CO₂ emission which goes against the current interests of the chemical industry where—in recent years—focus has been on reducing greenhouse gas emissions. In principle the external heating could also be provided by hydrogen combustion where the hydrogen is supplied by electrolysis. However, this route will require substantial electric power for producing the hydrogen and this option is therefore expensive and not preferred.

The present technology aims to provide an effective heat exchange reactor (HER) and process for production of CO from CO₂. In particular, in the present technology, the risk of metal dusting both on the process side and on the heating side is reduced, or totally avoided, where possible.

### SUMMARY

It has been found that the process and HER reactor used herein for CO₂ shift provide a much lower risk of metal dusting compared to a heat exchange steam methane reformer.

The invention is as defined in the independent claims.

In one embodiment, a process for converting a first gas feed comprising CO₂ and H₂ to a synthesis gas stream, via a CO₂ shift reaction of said first gas feed in a heat exchange reactor, HER is provided, wherein said HER comprises:
at least one process side and at least one heating side, wherein the process side of the HER comprises a process side inlet and a process side outlet,
wherein the process side of the HER comprises a first reaction zone (I) disposed closest to the process side inlet,
and wherein process side of the HER comprises a second reaction zone (II) disposed closest to the process side outlet,
wherein the heating side of the HER comprises a heating side inlet and—optionally—a heating side outlet,
said at least one process side and said at least one heating side, being arranged such that heat transfer from heating side to at least a part of the process side is possible,
   said process comprising the steps of:
supplying the first gas feed to the process side of the HER via said process side inlet;
supplying a heating fluid to the heating side of the HER via said heating side inlet, and allowing heat transfer from said heating fluid to the process side of the HER;
carrying out an overall exothermic reaction of said first gas feed in the first reaction zone (I), wherein the overall exothermic reaction comprises at least the following reactions, which have a net progress from left to right:

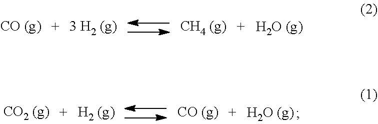

carrying out an overall endothermic reaction of gas from said first reaction zone in the second reaction zone (II), wherein the overall endothermic reaction comprises at least the following reactions, which have a net progress from left to right:

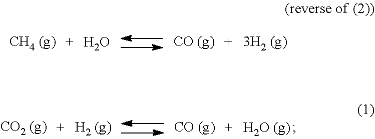

outletting the synthesis gas stream from the process side via the process side outlet optionally in admixture with a cooled fluid; and
optionally, outletting a cooled fluid from said heating side, via the heating side outlet.

A heat exchange reactor (HER) for carrying out this process is also provided. Further details of the present technology are provided in the following description text, the figures and the dependent claims.

### LEGENDS

The technology is described with reference to the enclosed schematic figures, in which:

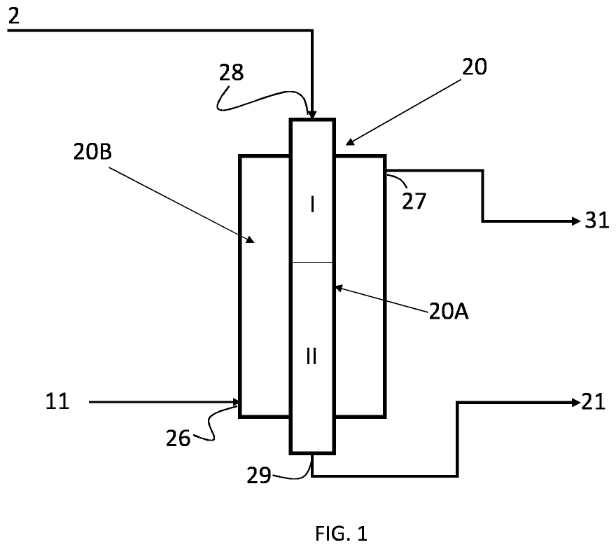

FIG. 1 shows an HER system according to the invention comprising a heat exchange reactor (HER)

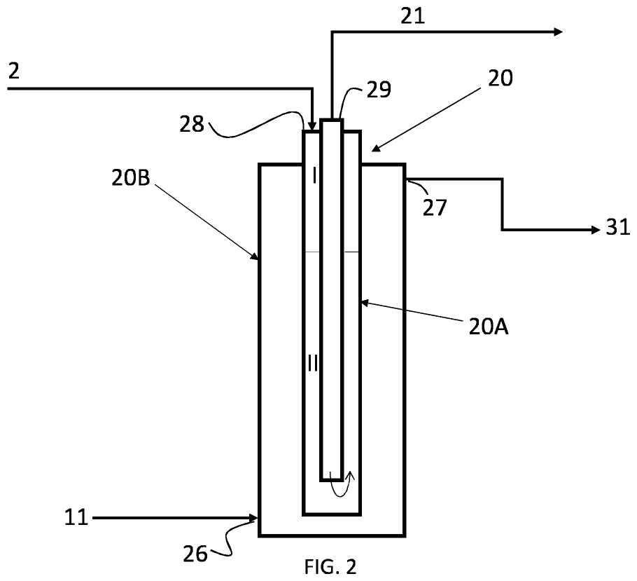

FIG. 2 shows a HER system similar to the system of FIG. 1, in which the HER reactor is a bayonet-type HER.

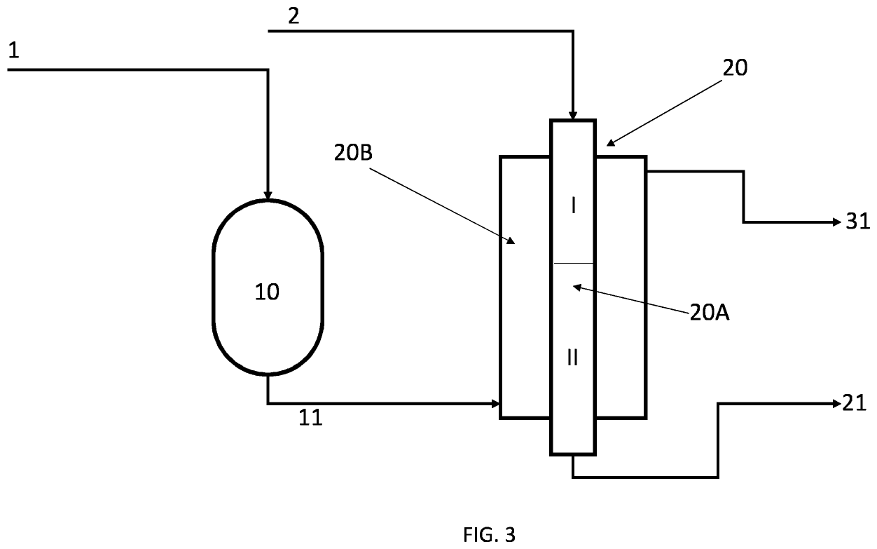

FIG. 3 shows a system according to the invention comprising, an electrical Reverse Water Gas Shift (e-RWGS) reactor and a heat exchange reactor (HER)

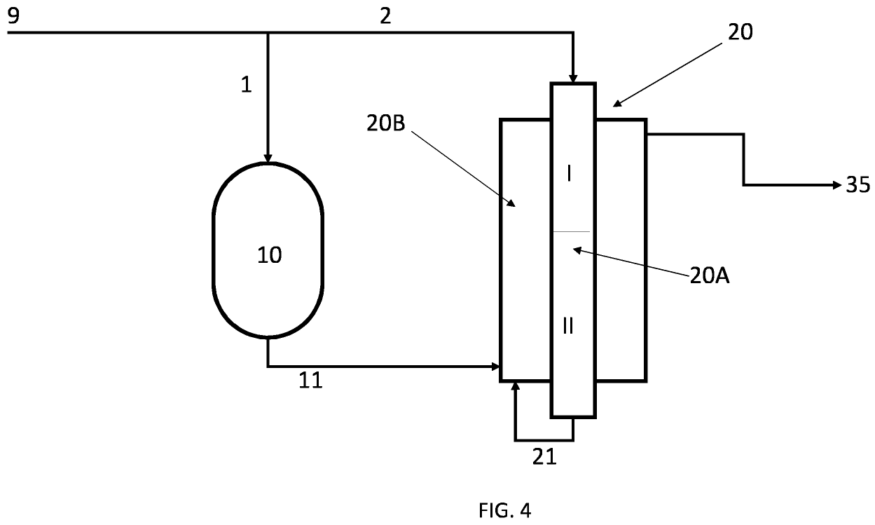

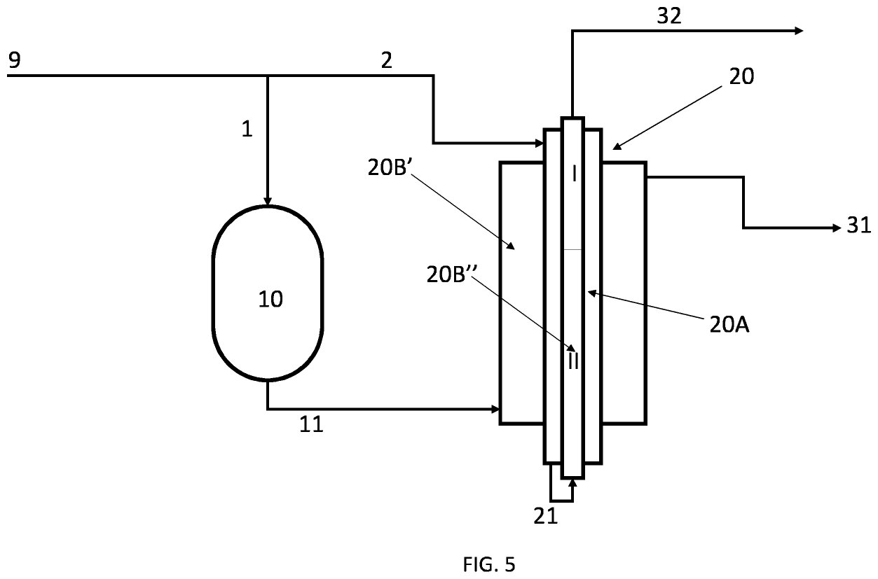

FIG. 4 shows a system similar to the system of FIG. 3, in which first and second feeds originate from a common feed.

FIG. 5 shows a system similar to the system of FIG. 5, in which the HER has two separate heating sides.

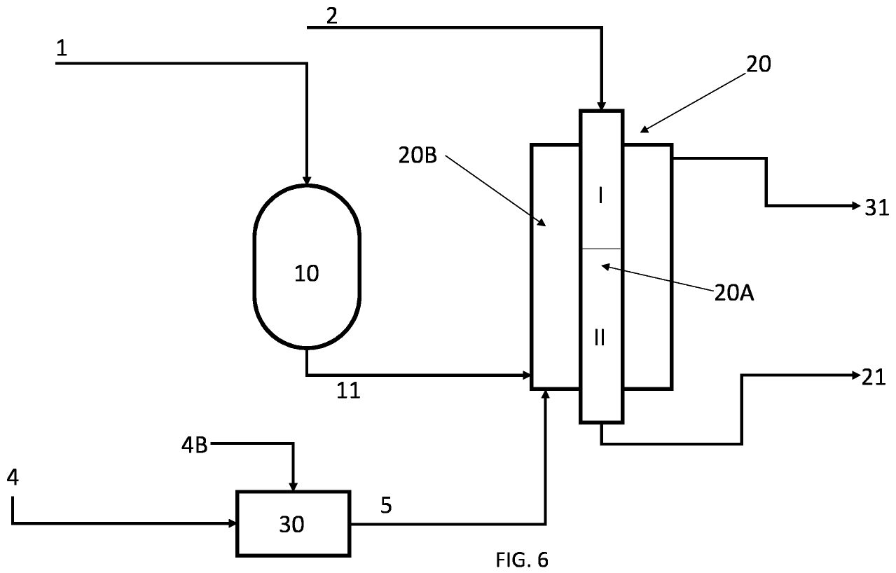

FIG. 6 shows a system according to the invention, further comprising a combustion unit.

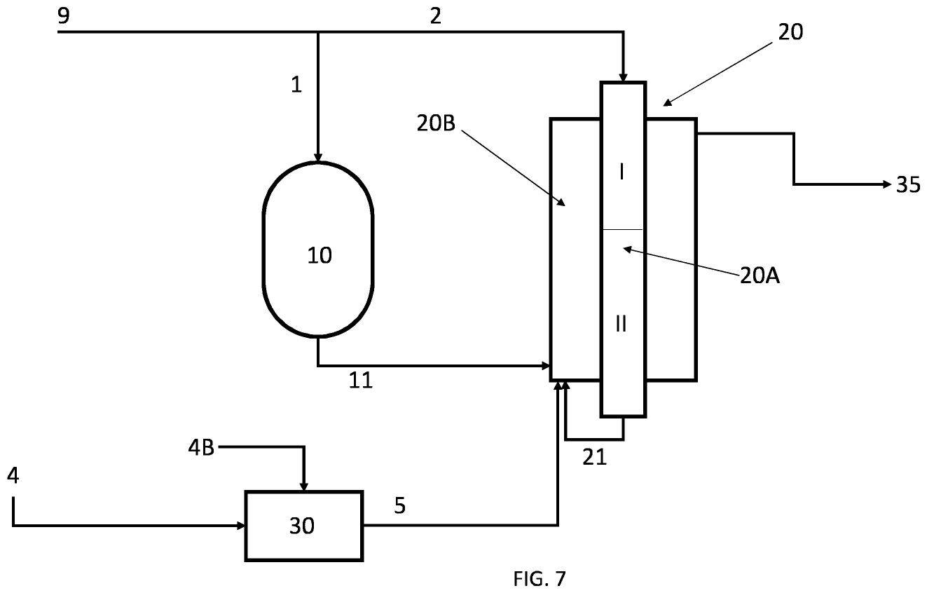

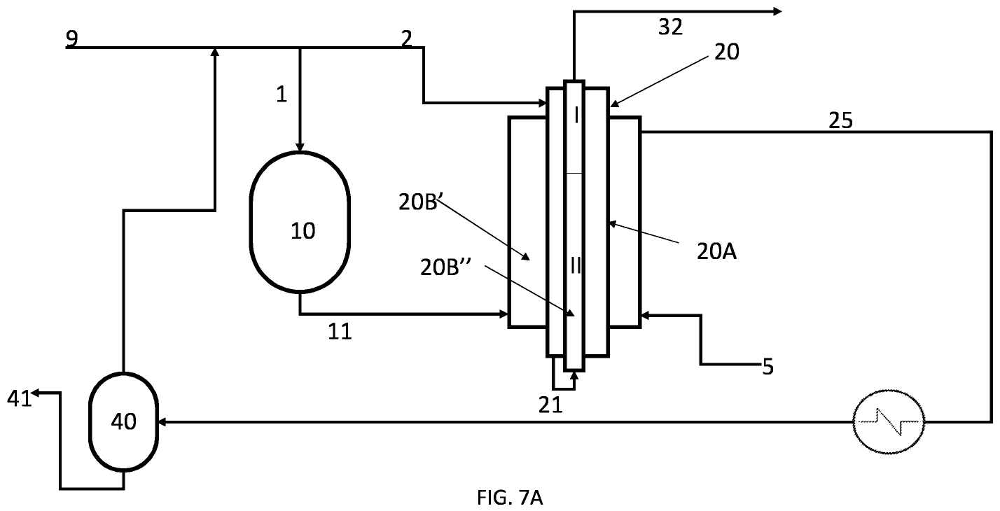

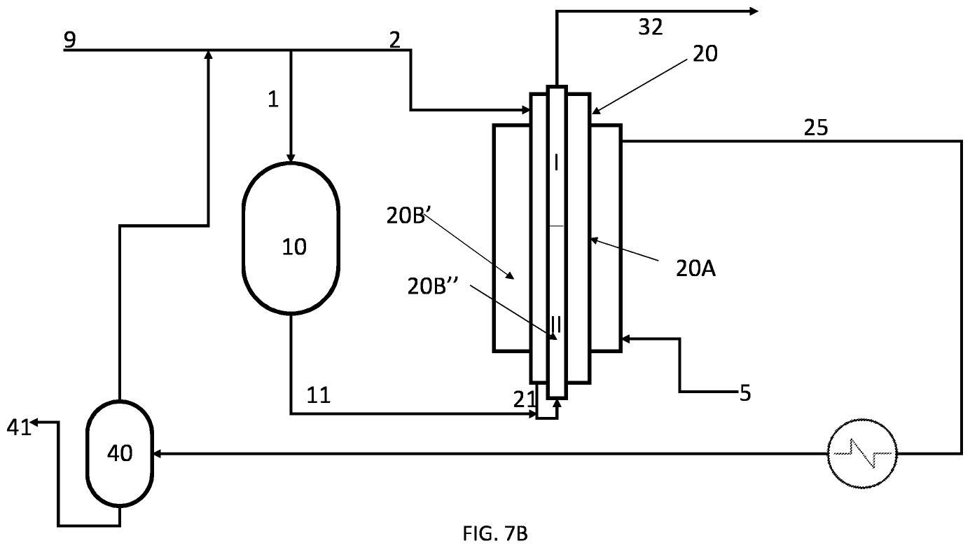

FIG. 7 shows a system similar to the system of FIG. 6, in which first and second feeds originate from a common feed.

FIG. 7A shows a system according to the invention, in which a flash separation unit is present to remove condensate

FIG. 7B shows a system similar to FIG. 7A

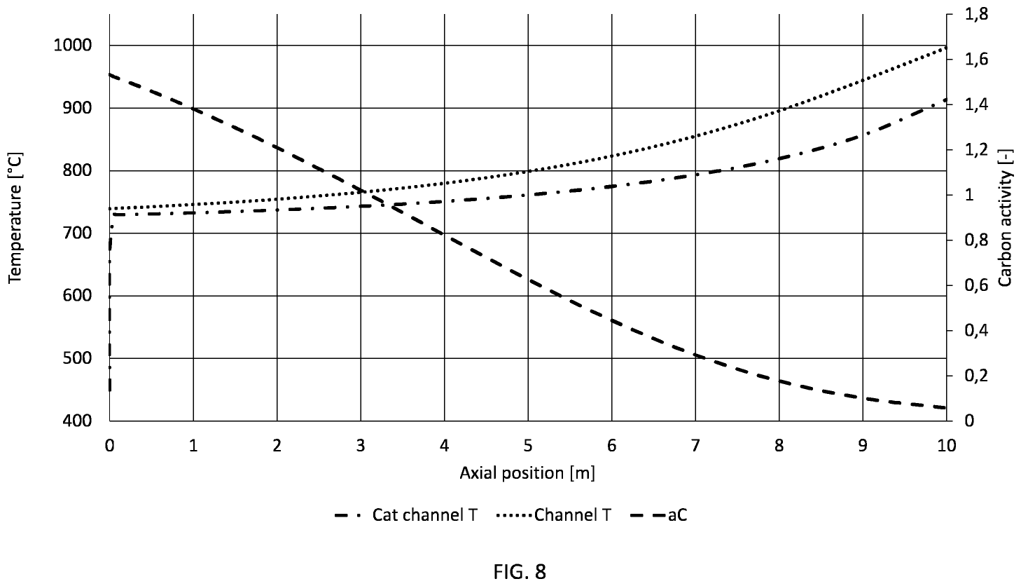

FIGS. 8-10 show temperature and actual gas carbon activity profile of the gas in the heating side of the HER for the examples 4, 5 and 6.

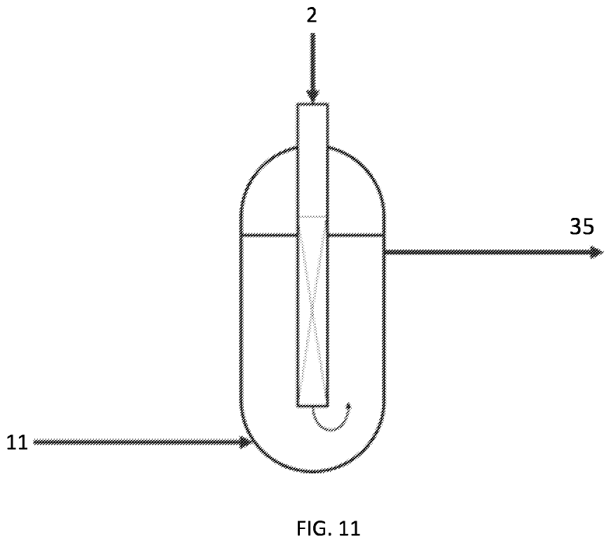

FIG. 11 shows an alternative arrangement of the HER of the invention, in which syngas stream and cooled fluid are combined before the HER outlet.

### DETAILED DISCLOSURE

Unless otherwise specified, any given percentages for gas content are % by volume.

The system may additionally comprise whichever additional units and connections (e.g. piping) the skilled person may consider necessary.

When using CO-containing gas for heating and consequently cooling, carbon formation through the so-called metal dusting phenomenon must be considered. The central carbon forming reactions to consider are the Boudouard reaction and CO reduction reactions described herein. Both reactions are exothermic and are consequently favored at lower temperatures.

A measure to evaluate the risk of carbon formation is the carbon activity (a_{C}) according to:

$${a}_{c} = {K}_{eq} ( CO red ) * p ( CO ) * p ( H 2 ) / p ( H 2 O )$$

Where K_{eq}(CO red) is the thermodynamic equilibrium constant of the CO reduction reaction, and p(i) is the partial pressure of i. Notice than when a_{C}<1 carbon formation cannot take place. The temperature at which a_{c}=1 is known as the Carbon Monoxide Reduction Temperature, T_{CO}.

A similar expression can be made for the Boudouard reaction. The temperature at which a_{c}=1 for the Boudouard reaction is known as the Boudouard Temperature, T_{B}.

In a first embodiment, a process is provided for converting a first gas feed comprising CO₂ and H₂ to a synthesis gas (syngas) stream, via a CO₂ shift reaction of said first gas feed in a specific heat exchange reactor, HER.

### Heat Exchange Reactor

An HER is configured to use a hot gas to supply the heat for the endothermic reaction by heat exchange, typically over a tube wall. An example of a configuration of a heat exchange reformer has several parallel tubes filled with typically pellet catalyst which receive the feed gas. In the bottom of the reactor, the product gas from the catalyst filled tubes is mixed with hot synthesis gas from upstream reforming units and the combined synthesis gas carries out heat exchange with the catalyst filled tubes. Other configurations of heat exchange reactors are also conceivable.

In a preferred embodiment, the catalyst of the HER is a non-selective catalyst. Examples of such catalysts include Ni/MgAl₂O₄, Ni/Al₂O₃, Ni/CaAl₂O₄, NiIr/MgAl₂O₄, Ni/ZrO₂, Ru/MgAl₂O₄, Rh/MgAl₂O₄, Ir/MgAl₂O₄, Ru/ZrO₂, NiIr/ZrO₂, MO₂C, Wo₂C, CeO₂, a noble metal on an Al₂O₃. Other examples include active metals such as nickel, iridium, rhodium, and/or ruthenium on various forms of calcium aluminate.

The HER has at least a process side and at least a heating side. The process side of the HER comprises a process side inlet and a process side outlet, while the heating side of the HER comprises a heating side inlet and—optionally—a heating side outlet. The respective inlets and outlets are in fluid connection, within each side of the HER.

Process sides and heating sides are separated from one another by internal wall(s), such that heat transfer from heating side to process side is possible. In one aspect, the HER may comprise two heating sides.

The process side of the HER is that side in which the CO₂ shift reaction takes place. The process side of the HER may comprise one or more catalysts which promote the CO₂ shift reaction. The catalysts also catalyse the methanation and the steam reforming reactions as explained below. The catalyst used in both reaction zones is suitably non-selective.

The heating side of the HER is not designed for chemical reactions to take place; instead, heat energy from hot fluid travelling through the heating side is transferred to the process side.

The HER may be a typical “shell and tube” heat exchange reactor, comprising a plurality of catalyst filled tubes located within a shell. There is a fluid connection between the interior of all tubes, but no fluid connection between interior and exterior of the tubes. In operation, one fluid flows through the interior of the tubes, while a second fluid flows in the shell, externally of the tubes. Heat is transferred from one fluid to the other, through the wall of the tubes. A manifold-type arrangement is located at each end of the bundle of tubes.

The HER will typically operate at a pressure close to any associated reactor(s), which in one aspect, is an RWGS reactor such as an e-RWGS.

As noted above, the process side of the HER comprises a process side inlet (through which first gas feed enters the HER) and a process side outlet (through which synthesis gas stream exits the HER). A first reaction zone (I) is disposed closest to the process side inlet, and a second reaction zone (II) is disposed closest to the process side outlet. The term “disposed closest” should be measured in terms of gas path, rather than geometrically.

The first reaction zone (I) is arranged to carry out an overall exothermic reaction of the first gas feed.

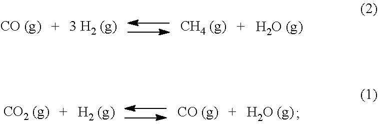

Both of these reactions take place in the first reaction zone (I).

The second reaction zone (II) is arranged to carry out an overall endothermic reaction of gas from said first reaction zone (I). Main reactions occurring in this zone are:

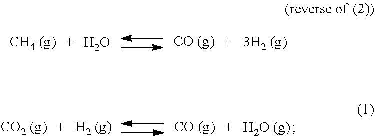

Typically, both the RWGS/Water gas shift reaction and the steam reforming/methanation reactions are at or close to chemical equilibrium at the outlet of the HER.

In one aspect, the process side of the HER has a total length extending from the process side inlet to the process side outlet, and wherein the first reaction zone (I) has an extension of less than 50%, such as less than 30%, preferably less than 20%, more preferably less than 10% of the total length of the process side of the HER. A first catalyst may be located at least in the first reaction zone (I), and may extend at least partly into the second reaction zone (II).

In another embodiment the same type of non-selective catalyst is used both in the first and second reaction zones. A non-selective catalyst catalyzes both reactions (1) and (2). The non-selective catalyst may in addition catalyse other reactions such as steam reforming of higher hydrocarbons such as ethane and propane.

Suitably, at least the end of the first reaction zone (I) which is located closest to the process side inlet of the HER is not directly in contact with the heating side of the HER, so that this end of the first reaction zone (I) is primarily heated by the adiabatic temperature rise caused by said exothermic reaction. The process side inlet of the HER is the end of the HER where the first gas feed enters.

It is essential to avoid carbon formation on the catalyst both in the HER reactor. Furthermore, it is well known that a risk of metal dusting exists when gases comprising CO are produced, and especially when such gases are cooled. The present invention avoids, or substantially reduces, the risk of both carbon formation and metal dusting in the HER reactor.

Metal dusting may occur on metallic walls in the presence of gases comprising CO. The chemical reaction leading to metal dusting is often one of the following:

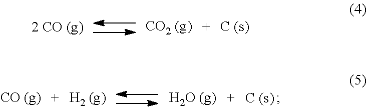

The first reaction is known as the Boudouard reaction and the second as the CO reduction reaction. Metal dusting may in severe cases lead to rapid degradation of metallic walls and result in severe equipment failure.

As a central part of the invention, the use of a non-selective catalyst is preferred to using a selective catalyst for several reasons as will be explained in the following:

When using a non-selective catalyst in the first reaction zone (I), methanation takes place in addition to the RWGS reaction. This results in release of chemical energy to heat the system and a resulting temperature increase as the methanation is exothermic. As the CO reduction reaction is also exothermic, the increase in temperature created by the methanation reaction results in a reduction of the potential for the CO reduction reaction and when the temperature has risen to a certain level, no potential for the CO reduction reaction will be present at all. This exact level will be dependent on the specific reactant concentration, inlet temperature, and pressure, but will typically be in the range from 500-800° C. above which the CO reduction reaction will not have a potential to take place. Notice, that the exotherm generated by the methanation reaction will give the highest temperature rise at the active site of the catalysts on the surface of the structured catalyst which is also the place where carbon formation can take place. Consequently, this exotherm has a pronounced positive effect for reducing the carbon formation potential on the catalyst.

Overall, the configuration of this HER allows for facilitating the reverse water gas shift reaction and the methanation reaction within the HER, without having a side-reaction of carbon formation on the catalyst or the metallic surfaces, as the methanation reaction counterintuitively mitigates this. The specific configuration of the HER which allows for increasing the temperature from a relative low inlet temperature to a very high product gas temperature of more than 500° C., preferably more than 800° C., and even more preferably more than 900° C. or 1000° C. means that the resulting methane formed from the methanation reaction will occur in the first reaction zone (I) of the HER reactor, but when exceeding ca. 600-800° C. this methane will start to be converted by the reverse methanation reaction back to a product rich in CO. This configuration elegantly allows for removing some of the CO and generation of some H₂O inside the catalyst bed in the temperature region where CO reduction is a problem, but then allows for reproducing the CO in the high temperature zone with low or no carbon potential. Effectively, utilizing the high product gas temperature means that the final syngas product can be delivered with a very low methane concentration, despite the methane having a peak concentration somewhere along the reaction zone. In an embodiment, the reactor system is operated with none, or very little, methane in the first gas feed and only very little methane in the syngas stream, but with a peak in methane concentration inside the reaction zone higher than in the first gas feed and/or syngas stream. In some cases, this peak methane concentration inside the reaction zone may be an order of magnitude higher than the inlet and outlet methane concentrations.

As indicated above, the CO-concentration and the potential for carbon formation is low when using a non-selective catalyst. Assuming that the gas in the process side of the HER reactor is in equilibrium with respect to reactions (1) and (2), there will typically be no thermodynamic potential for carbon formation by either of reactions (4) and (5). If a selective catalyst is used and only reaction (1) takes place (i.e. reaction (2) does not take place), the CO concentration will be significantly higher. In this case there will typically be thermodynamic potential for carbon formation from both reactions (4) and (5) and, hence, the risk of carbon formation is substantially higher.

### First Gas Feed

A first gas feed comprising CO₂ and H₂ is required. This first feed may be or comprise a combustion product of another gas composition external to the system. Examples of CO₂ sources include flue gas or off-gas from CO₂ capture units such as amine wash units, biogenic CO₂, CO₂ from direct air capture units and/or CO₂ from cement or steel factories. Examples of H₂ sources include hydrogen produced from electrolysis (for example alkaline or Solid Oxide Electrolysis) or hydrogen produced from steam reforming. First gas feed is converted to a synthesis gas stream via a CO₂ shift reaction of the first gas feed in a heat exchange reactor.

Part of the first feed and/or the heating fluid used in the process may also comprise a recycle gas from a downstream unit. An example is the recycle of an off-gas (or tail gas) from a Fischer-Tropsch synthesis unit. Such a tail gas may be pre-treated before being used as part or all of the first feed and/or the heating fluid. Another example is the purge gas from a methanol loop.

Suitably, the first feed comprises between 10-60% CO₂, such as e.g. between 20-35% CO₂, between 25-35% CO₂. Suitably, the first feed comprises between 40-90% H₂, such as e.g. between 50-80% H₂, between 60-70% H₂ or between 65-70% H₂.

In the first feed, the ratio between H₂ and CO₂ may be between 1-5, such as e.g. between 2-4, between 2-3 or between 2.2-2.5, or between 2.8-3.5, or between 2.8 and 3.2. In a further embodiment, the molar ratio of CH₄/CO₂ in the first feed is preferably less than 0.5, such as less than 0.2, preferably less than 0.1.

Suitably, the main source of hydrogen in the first gas feed is an electrolysis unit.

Part of the first feed may further originate from a hydrocarbon containing stream which has been prereformed upstream the HER reactors according to the following reaction:

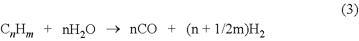

The above reaction is typically accompanied by the methanation reaction and the water gas shift reaction (reverse of reaction (1)) resulting in a mixture of mainly CO₂, H₂, CH₄, and steam.

An example of a hydrocarbon stream is a stream comprising paraffins such as ethane, propane, butanes, and/or pentanes. For paraffins, m=2n+2 in equation (3).

Another example of a hydrocarbon stream is LPG which is recycled from a synthesis section downstream the system of the invention, such as recycle from a Fischer-Tropsch synthesis unit or a unit producing hydrocarbons from methanol.

The first feed may in addition comprise other components such as CH₄, N₂, Ar, O₂, CO, or H₂O. Other components such as other hydrocarbons including ethane are also conceivable typically in minor amounts.

The first feed suitably has the following composition (by volume):
50-80% H₂ (dry)
20-50% CO₂ (dry)

In an embodiment the first feed suitably has the following alternative composition by volume:
50-70% H₂
20-40% CO₂
2-10% CH₄
1-8% H₂O
0-5% CO
0-5% other components in total such as Ar, N₂, and ethane.

In a further embodiment, where the natural gas is preconditioned by desulfurisation and/or prereforming, the carbon from natural gas comprises less than 20, preferably less than 10%, more preferably less than 5% of the total amount of carbon in the first feed.

The first gas feed may additionally comprise methane, suitably up to 3 mole %, or up to 8 mole %, or up to 12 mole % methane.

The first gas feed is supplied to the process side of the HER via said process side inlet. In a particular embodiment, the first gas feed has a temperature of 250° C. to 550° C., preferably from 260° C. to 450° C., preferably from 270° C. to 400° C., preferably from 280° C. to 380° C., preferably from 290° C. to 370° C., and most preferably from 300° C. to 360° C.

### Heating Fluid

A heating fluid is also required in the system. This heating fluid may be partly or completely a combustion product of another gas composition external to the system. Suitably, the heating fluid comprises CO₂ and H₂, and may also be a syngas stream.

Heating fluid is supplied to the heating side of the HER via said heating side inlet, and heat transfer from said heating fluid to the process side of the HER takes place.

In one aspect, the heating fluid is provided from an electrical RWGS (e-RWGS) reactor, a fired RWGS reactor or an autothermal RWGS reactor, preferably an electrical RWGS (e-RWGS) reactor.

In one embodiment, where the heating fluid is a syngas stream, the synthesis gas stream and the cooled fluid may be combined in the HER to provide a third product stream from the process side outlet. In other words, the synthesis gas leaving the second reaction zone is mixed with the hot heating fluid—this mixture is then cooled and the cooled fluid outlet from the HER reactor.

As noted above, the heating fluid may be provided from an electrical RWGS (e-RWGS) reactor, a fired RWGS reactor or an autothermal RWGS reactor, preferably an electrical RWGS (e-RWGS) reactor.

In one aspect, the RWGS reactor used for carrying out the reverse water-gas shift reaction between CO₂ and H₂ is an electrically-heated reverse water gas shift (e-RWGS) reactor. An e-RWGS reactor uses an electric resistance-heated reactor to perform a more efficient reverse water gas shift process and substantially reduces or preferably avoids the use of fossil fuels as a heat source. The e-RWGS reactor may comprise a catalyst that is either selective or non-selective. Preferably, the eRWGS reactor comprises a catalyst which is non-selective.

In an embodiment, the e-RWGS reactor suitably comprises:
a structured catalyst arranged for catalysing said RWGS reaction, said structured catalyst comprising a macroscopic structure of electrically conductive material, said macroscopic structure supporting a ceramic coating, wherein said ceramic coating supports a catalytically active material (for selective e-RWGS);
a structured catalyst comprising a macroscopic structure of electrically conductive material said macroscopic structure supporting a ceramic coating, wherein said ceramic coating supports a non-selective catalytically active material (for non-selective e-RWGS);
optionally a top layer, comprising a non-selective pellet catalyst,
a pressure shell housing said structured catalyst; said pressure shell comprising an inlet for letting in said feed and outlet for letting syngas product; wherein said inlet is positioned so that said feed enters said structured catalyst in a first end of said structured catalyst and said syngas product exits said structured catalyst from a second end of said structured catalyst;
a heat insulation layer between said structured catalyst and said pressure shell; and
at least two conductors electrically connected to said structured catalyst and to an electrical power supply placed outside said pressure shell, wherein said electrical power supply is dimensioned to heat at least part of said structured catalyst to a temperature of at least 500° C. by passing an electrical current through said macroscopic structure of electrically conductive material; wherein said at least two conductors are connected to the structured catalyst at a position on the structured catalyst closer to said first end of said structured catalyst than to said second end of said structured catalyst, and wherein the structured catalyst is constructed to direct an electrical current to run from one conductor substantially to the second end of the structured catalyst and return to a second of said at least two conductors.

The pressure shell suitably has a design pressure of between 2 and 50 bar. The pressure shell may also have a design pressure of between 50 and 200 bar. The at least two conductors are typically led through the pressure shell in a fitting so that the at least two conductors are electrically insulated from the pressure shell. The pressure shell may further comprise one or more inlets close to or in combination with at least one fitting in order to allow a cooling gas to flow over, around, close to, or inside at least one conductor within said pressure shell. The exit temperature of gas from the e-RWGS reactor is suitably 900° C. or more, preferably 1000° C. or more, even more preferably 1100° C. or more.

The eRWGS reactor may also be of a different design and/or the heat may be transferred by induction.

The eRWGS reactor may alternatively comprise a first heating end where the feed gas is heated by electrical heating to a high temperature such as 800-1000° C. and a second end comprising an (adiabatic) catalyst bed containing either a selective or non-selective catalyst, or a combination of catalysts.

In an embodiment, the RWGS reactor is a fired RWGS reactor. A fired RWGS reactor could consist of a number of tubes filled with catalyst pellets placed inside a furnace. The tubes are typically quite long, such as 10-13 meters, and will typically have a relative small inner diameter, such as between 80 and 160 mm, to collectively provide a high externally exposed surface area to facilitate heat transfer into the catalyst. The catalyst can be either a selective or non-selective catalyst, or a combination. The fired RWGS reactor requires a fuel gas. Burners placed in the furnace provide the required heat for the reactions by combustion of the fuel gas. There is a general limitation to the obtainable heat flux due to mechanical constraints and the capacity is therefore increased by increasing the number of tubes and the furnace size. This type of reactor configuration has been frequently used for steam reforming, where more details can be found in the art such as “Synthesis gas production for FT synthesis”; Chapter 4, p. 258-352, 2004. Other types of fired RWGS reactors can also be envisaged.

In an embodiment, the RWGS reactor is an autothermal RWGS reactor or more preferably one or more pre-reactors followed by a downstream autothermal RWGS reactor. The effluent gas from the first pre-reactor may optionally be cooled and sent to the next pre-reactor in which the same reactions occur. Further pre-reactors may be used. The pre-reactors are typically adiabatic or heated. The exit gas from the last pre-reactor is sent to an autothermal RWGS reactor.

In the pre-reactor(s) reactions (1) and (2) take place. Typically, the gas composition both at the outlet of each of the pre-reactors and the autothermal RWGS reactor are at or close to chemical equilibrium at the outlet with respect to reactions (1) and (2).

The main elements of an autothermal RWGS reactor are a burner, a combustion chamber, and a catalyst bed contained within a refractory lined pressure shell. An autothermal RWGS reactor requires a feed of oxygen. In an autothermal RWGS reactor, partial combustion of the autothermal RWGS reactor feed by sub-stoichiometric amounts of oxygen is followed by reverse water gas shift and optionally also steam reforming of the partially combusted gas in a fixed bed of catalyst. Typically, the gas is at or close to equilibrium at the outlet of the reactor with respect to water gas shift and steam reforming reactions. The temperature of the exit gas is typically in the range between 850 and 1100° C. This type of reactor configuration has been frequently used for synthesis gas production from hydrocarbon feedstock, where more details can be found in the art such as “Studies in Surface Science and Catalysis, Vol. 152,” Synthesis gas production for FT synthesis“; Chapter 4, p. 258-352, 2004”.

A fired RWGS reactor followed by an autothermal RWGS reactor may also be used. In this case the effluent from the RWGS reactor is directed to the autothermal RWGS reactor. The effluent gas from the fired RWGS reactor would in this case typically be between 700-900° C.

An electrical RWGS reactor followed by an autothermal RWGS reactor is also conceivable. The effluent gas from the electrical RWGS reactor would in this case typically be between 700-900° C.

The present invention also provides a heat exchange reactor (HER), for converting a first gas feed comprising CO₂ and H₂ to a synthesis gas stream, via a CO₂ shift reaction of said first gas feed. The HER comprises:
at least one process side and at least one heating side, wherein the process side of the HER comprises a process side inlet and a process side outlet,
said process side inlet being arranged to supply said first gas feed comprising CO₂ and H₂ to said process side,
said process side outlet being arranged to output said synthesis gas stream from said process side, optionally in admixture with a cooled fluid,
wherein the process side of the HER comprises a first reaction zone (I) disposed closest to the process side inlet,
and wherein process side of the HER comprises a second reaction zone (II) disposed closest to the process side outlet,
wherein the first reaction zone (1) is arranged to carry out an overall exothermic reaction of said first gas feed, wherein the overall exothermic reaction comprises at least the following reactions, which have a net progress from left to right:

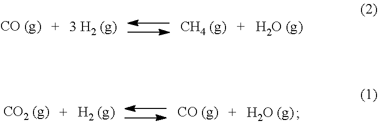

wherein the second reaction zone (II) is arranged to carry out an overall endothermic reaction of gas from said first reaction zone, wherein the overall endothermic reaction comprises at least the following reactions, which have a net progress from left to right:

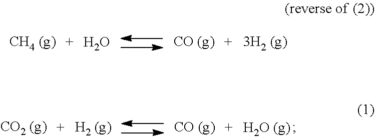

wherein the heating side of the HER comprises a heating side inlet and—optionally—a heating side outlet,
said heating side inlet being arranged to supply a heating fluid to said heating side,
said heating side outlet—when present—being arranged to output a cooled fluid from said heating side,
said at least one process side and said at least one heating side, being arranged such that heat transfer from heating side to process side is possible.

The system may additionally comprise whichever additional units and connections (e.g. piping) the skilled person may consider necessary.

The process side of the HER suitably has a total length extending from the process side inlet to the process side outlet, and wherein the first reaction zone (I) has an extension of less than 50%, such as less than 30%, preferably less than 20%, more preferably less than 10% of the total length of the process side of the HER. A first catalyst is suitably located at least in the first reaction zone (1) of the HER. At least an end section of the process side of the first reaction zone (I) which is located closest to the process side inlet of the HER, and which has an extension of up to 25% of the total extension of the process side of the first reaction zone in the direction from the process side inlet towards the process side outlet, is not directly in contact with the heating side of the HER, so that this end section of the first reaction zone (I) is primarily heated by the adiabatic temperature rise caused by the exothermic reaction in the first reaction zone (I). In particular, said end section has an extension of 5-20%, preferably 5-10%, of the total extension of the process side of the first reaction zone in the direction from the process side inlet towards the process side outlet. The HER is suitably a bayonet-type HER. The HER may have at least two process sides, and/or at least two heating sides.

The H₂/CO-ratio of the syngas stream output from the HER is suitably between 1.8 and 2.2 such as between 1.9 and 2.1. This is desirable for example if the synthesis gas is to be used for downstream synthesis of synthetic fuels such as kerosene or diesel by the Fischer-Tropsch synthesis.

In one embodiment, the (H₂—CO₂)/(CO+CO₂) ratio (also known as synthesis gas module) of the syngas stream output from the HER is between 1.8 and 2.2 such as between 2.0 and 2.1. This is desirable for example if the synthesis gas is to be used for downstream synthesis of methanol.

An overall exothermic reaction of the first gas feed is carried out in the first reaction zone (I); an overall endothermic reaction of the gas from the first reaction zone (I) is carried out in the second reaction zone (II); and the synthesis gas stream is outlet from the process side (of the HER) via the process side outlet, optionally in admixture with a cooled fluid. A cooled fluid may be outlet from the heating side of the HER, via the heating side outlet.

The temperature of the gas in the first reaction zone (I) is typically between 300-800° C. The temperature of the gas in the second reaction zone (II) is typically between 600-1200° C.

Suitably, the process conditions are adjusted to provide a temperature of the synthesis gas stream and/or the cooled fluid, and/or the third product stream at the respective outlet of the HER which is higher than the critical limit for metal dusting. This means that the temperature is high enough such that either there is no thermodynamic potential for metal dusting or that the thermodynamic potential is low enough such that either metal dusting does not occur or occurs at a very low rate.

For instance, the cooled exit temperature of the synthesis gas stream and/or the cooled fluid, and/or the third product stream is 500° C. or higher, 600° C. or higher, 700° C. or higher, or 800° C. or higher. By controlling the cooled product stream temperature, the risk of metal dusting can be controlled, where in general lower temperatures favours increased (and unwanted) potential (higher a_{c}) towards metal dusting due to the exothermic nature of the associated reactions.

The synthesis gas stream and/or the cooled fluid, and/or the third product stream, at said cooled exit temperature suitably has a CO reduction reaction actual gas carbon activity lower than 100, or lower than 50, or lower than 10, or lower than 5, or lower than 1.

Typically, the H₂/CO ratio of the synthesis gas stream and/or the cooled fluid, and/or the third product stream, is in the range from 0.5 to 3.0, such as in the range 1.9-2.1, or in the range 2-3. Also, the (H₂—CO₂)/(CO+CO₂) ratio of the synthesis gas stream and/or the cooled fluid, and/or the third product stream, may be in the range from 1.5 to 2.5, such as in the range 1.9-2.1, or in the range 2-2.05.

The control of the cooled exit temperature of the synthesis gas stream and/or the cooled fluid, and/or the third product stream can be performed by proper design of the HER reactor. One way of accomplishing this is to minimize or eliminate the transfer of heat from the heating side to the process side in reaction zone (I). As described above in a preferred embodiment most or all of the temperature increase in reaction zone (I) is caused by the adiabatic temperature increase due to the methanation reaction using a non-selective catalyst. In a preferred embodiment, the temperature of the gas leaving the first reaction zone (I) is above 650° C., more preferably above 700° C., and most preferably above 750° C. The temperature of the gas leaving the HER reactor from the heating side must be above the temperature of the of the gas leaving reaction zone (I) on the process side if no heat transfer between the process side and the heating side take place in reaction zone (I). Hence, one means to maintain a high temperature of the gas (e.g. cooled first product gas) leaving the HER reactor from the heating side is to prevent or minimize heat transfer in the HER reactor in reaction zone (I). This can for example be done by:
1) Install an adiabatic non-selective catalyst upstream the HER reactor as described above.
2) Most or all of the first reaction zone (I) is not in direct heat contact with the heating side in/of the HER.
3) Means such as insulation are provided in part of the HER reactor between the process side and the heating side at least in part of reaction zone (I).

In one embodiment according to 1) or 2) above, the first gas feed reacts adiabatically according to reactions (1) and (2) to (or close to) equilibrium.

Mixing means may be located downstream the HER, and arranged to combine the synthesis gas stream and the cooled fluid. This arrangement is advantageously used in the case where both the synthesis gas stream and the cooled fluid are to be used for the same downstream application, wherefore mixing just as well can be done in the HER to in this way maximize utilization of heat transfer area in the equipment.

The HER may have two separate heating sides. Such an HER is illustrated in FIG. 3.

In a specific embodiment, the HER comprises a number of double tubes. Double tubes are understood as two concentric tubes with similar length where the inner tube has a smaller diameter than the outer tube. In this arrangement, catalyst is placed both in the inner tubes and between the outer tubes. Part of the first feed gas flows from the HER reactor inlet through the catalyst filled inner tubes to the other end of the HER reactor. The remaining part of the first feed gas flows through the catalyst filled areas between the outer tubes. The heating fluid consists of the gas leaving the catalyst filled inner tubes and the catalyst filled areas between the outer tubes are mixed with the synthesis gas, yielding a third product gas. The third product gas flows in essentially countercurrent mode through the annular space between the inner and outer tubes yielding a cooled third product gas. The cooling of the third product gas provides the required heat for the process sides (the catalyst filled inner tubes and the area between the outer tubes). This is an example of a system in which the HER has two process sides.

In a further embodiment the third product stream is further cooled in a heat exchanger (waste heat boiler) in which the heat is used to generate steam from a stream of water. This further cooled third product stream will typically have a temperature of 300-550° C. The steam produced can be used for a variety of purposes such as use for electricity production or as feed stream for an electrolysis unit for producing hydrogen. In this case the electrolysis unit can be arranged in series with the HER reactor. The hydrogen produced in the electrolysis unit can be added directly to the HER reactor as part or all of the hydrogen in the first gas feed.

The further cooled third product stream may have a temperature of 300-550° C. after being used for steam generation as described above. This further cooled third product stream can subsequently also be used for additional heating such as for example preheating of part or all of the first gas feed. Even if the further cooled third product stream has a high content of carbon monoxide, severe metal dusting can be avoided as the temperature of the heat transfer surfaces is sufficiently low.

The third product stream may be used as heat source for example for preheating part or all of the first gas feed. This has the advantage of optimizing the energy efficiency. The preheating of the first gas stream and the generation of steam may take place either in parallel or in series.

In one aspect, the system may further comprise a combustion unit and a fourth feed of fuel, wherein said third feed of fuel is arranged to be fed to the combustion unit and combusted therein in the presence of an oxidant to provide a fifth feed of combusted gas, wherein said fifth feed is arranged to be fed to the heating side of the HER, as a portion of, or the entirety of said heating fluid. Preferably, the oxidant in said combustion unit is substantially pure oxygen, preferably more than 90% oxygen, most preferably more than 99% oxygen. This allows the option of boosting the transferred duty of the HER to thereby facilitate increased CO production in the second product stream.

The third feed of fuel may be a feed comprising hydrogen, which is combusted to a fifth feed, being a feed comprising steam. Having substantially pure steam as the fifth feed is advantageous when this is mixed with the synthesis gas stream, because the steam easily is removed again and thereby will not influence the product quality of the produced synthesis gas.

Alternatively, the third feed of fuel may be a feed comprising methane and/or other hydrocarbons, such that the fifth feed is a feed comprising carbon dioxide and steam. CO₂ can in this way advantageously be recovered from downstream the HER and be used as input to upstream feedstock(s). In an embodiment, the external burner is running substochiometric and the fifth feed could comprise CH₄, CO, and/or H₂. In particular, it is of interest if H₂ is substoichiometric with respect to O₂.

When the 5^{th} feed is fed separately to the heating side of the HER, as above, the cooled fifth feed may be used downstream the HER as part of said first gas feed comprising CO₂ and H₂. Cooling of this feed may result in condensation of part of the steam therein.

Typically, the cooled fifth feed will be cooled sufficiently to condense H₂O before being sent to the feed side (cf. FIG. 7). The system may therefore include an optional condensation stage.

The syngas produced by the system and the process above may be used for instance for producing methanol, synthetic gasoline, synthetic jet fuel or synthetic diesel.

### Specific Embodiments

FIG. 1 shows a general embodiment of an HER 20 of the invention. First gas feed 2 is supplied to the process side 20A of the HER 20 via process side inlet 28. Heating fluid 11 is fed to the heating side 20B of the HER 20 such that heat from the heating fluid 11 is transferred to the process side 20A of the HER 20. Conversion of the first gas feed 2 to a synthesis gas stream 21 comprising CO in the process side 20A of the HER 20 is thus promoted; whereby an overall exothermic reaction of said first gas feed 2 takes place in the first reaction zone (I); and an overall endothermic reaction of the gas from the first reaction zone (I) takes place in the second reaction zone (II). Cooled fluid 31 is outputted from the heating side outlet 27. The exit temperature of the cooled fluid 31 from the HER is ca. 500° C. or higher.

FIG. 2 shows a further embodiment of an HER 20, being a bayonet HER. Reference numbers are as FIG. 1.

FIG. 3 shows a general embodiment of a system 100 comprising an HER 20 of the invention and a Reverse Water Gas Shift (RWGS) reactor 10. First feed 1 comprising CO₂ and H₂ is fed to Reverse Water Gas Shift (RWGS) reactor 10, where it is also converted into a first product stream 11; i.e. a syngas stream. The outlet temperature of the RWGS reactor (i.e. the first product stream 11) is >1000° C., so this stream can be used as heating fluid in the downstream HER. First feed 2 is fed to process side 20A of the HER 20 and converted therein to synthesis gas stream 21. The HER is operated with an outlet temperature (i.e. the synthesis gas stream 21) of 950° C. The first product stream 11 is fed to the heating side 20B of the HER 20 such that heat from the first product stream 11 is transferred to the process side 20A of the HER 20. Conversion of the second feed 2 to a second product stream 21 comprising CO in the process side 20A of the HER 20 is thus promoted; and a cooled first product stream 31 is provided. The exit temperature of the cooled first product stream 31 from the HER is ca. 500° C. or higher.

FIG. 4 shows an embodiment of a system 100 similar to that of FIG. 3, in which reference numbers are as in FIG. 3. Additionally, for this system, a primary feed 9 comprising CO₂ and H₂ is divided into the first feed 2 and second feed 1. The primary feed 9 has a feed rate of 10000 Nm³/h and contains around 70% H2 and 30% CO₂. In this embodiment, first and second feeds are of equal molar sizes. Remaining details are as per FIG. 3.

In the embodiment of FIG. 5, a system 100 similar to that of FIG. 4 is provided, in which reference numbers are as in FIG. 4. Additionally, the HER 20 has first 20B′ and second 20B″ heating sides. Heating fluid 11 is fed to first heating side 20B′, while synthesis gas stream 21 is fed to second heating side 20B″. A cooled fluid 31 is outlet from the first heating side 20B′ of the HER, while a cooled synthesis gas stream 32 is outlet from the second heating side 20B″.

In the embodiment of FIG. 6, a system 100 similar to that of FIG. 3 is provided, in which reference numbers are as in FIG. 3. Additionally, this system comprises a combustion unit 30 and a third feed 4 of fuel. The third feed 4 of fuel is arranged to be fed to the combustion unit 30 and combusted therein in the presence of an oxidant 4B (typically an O₂ stream) to provide a fifth feed 5 of combusted gas. Fifth feed 5 is fed to the heating side 20B of the HER as an additional source of heat.

FIG. 7 shows a system 100 similar to that of FIG. 6, in which first feed 2 and second feed 1 originate from the same primary feed 9 in the same manner as in the embodiment of FIG. 4.

The embodiment in FIG. 7A is based on the embodiment of FIG. 5. In this embodiment, the fifth feed 5 of combusted gas is passed through the heating side of the HER and the cooled fifth feed 25 is used downstream the HER as part of said second feed 1 and/or as part of said first feed 2 comprising CO₂ and H₂. In the illustrated embodiment, a flash separator 40 is used to remove a stream of water 41, and the remainder of the fifth feed 25 is recycled to the primary feed 9.

The embodiment in FIG. 7B is based on the embodiment of FIG. 7A. In this embodiment, the heating fluid 11 is combined with the synthesis gas stream 21, to form a third product stream, which is fed to the heating side of the HER.

FIG. 11 shows an alternative arrangement of the HER of the invention, in which syngas stream 21 and cooled fluid 31 are combined before the HER outlet.

### EXAMPLES

### Comparative Example 1

As a first example a comparative case is illustrated using a stand-alone e-RWGS reactor with a non-selective catalyst. The operation of this process is summarized in Table 1, where a total feed of 10000 Nm³/h containing 69.2% H₂ and 30.8% CO2 is converted into a synthesis gas with a H₂/CO ratio of 1.88 by using 3.21 GCal/h in the e-RWGS reactor, corresponding to 1340 kcal per Nm³ CO produced.

TABLE 1

| Stream | 1 | 11 |
|---|---|---|
| T [° C.] | 450 | 1050 |
| P [barg] | 11.5 | 10.0 |
| Flow [Nm³/h] | 10000 | 9988 |
| Composition [mole %] | | |
| H2 | 69.2 | 45.1 |
| CO2 | 30.8 | 6.8 |
| N2 | 0.0 | 0.0 |
| CO | 0.0 | 24.0 |
| H2O | 0.0 | 24.1 |
| CH4 | 0.0 | 0.1 |

### Example 2

As a first example of the invention, a combination of a e-RWGS and a HER is illustrated in Table 2 for production of synthesis gas suitable for Fischer-Tropsch synthesis. In this case a primary feed of 10000 Nm³/h containing 69.2% H₂ and 30.8% CO₂ is separated into a first and a second feed of equal molar sizes to be fed into respectively a e-RWGS and a HER. The stream from the e-RWGS again produces a synthesis gas with a H₂/CO ratio of 1.88 by heating and converting the gas according to thermodynamics to 1050° C. The HER is operated with an outlet temperature of 950° C. (as given partly by the available temperatures from the heating gases) and receives 50% of the molar flow from the primary feed (i.e. 50% of the combined molar flow of the first and second feed). The first and the second product streams are mixed as used as heating source for the HER which cools the gas to 646° C., i.e. leaving 196° C. of driving force for the heat exchange. Overall, the combined synthesis gas has a H₂/CO ratio of 1.94, which is slightly higher than the comparative example. However, this is also done using only 689 kcal per Nm³ CO, which is 49% reduced duty compared to the comparative example. Specifically, the duty required for e-RWGS is 1.6 Gcal/h, while the duty transferred to the process side of the HER is 1.4 Gcal/h and the HER thereby constitutes 46% of the total transferred duty to process side across the two reactors. This duty split roughly reflects split in CO production, where 49% of the CO production is done in the HER.

The carbon activity for the CO reduction reaction of the combined (i.e. third) cooled product gas is 6.2.

TABLE 2

| Stream | 1 | 2 | 11 | 21 | 35 |
|---|---|---|---|---|---|
| T [° C.] | 450 | 450 | 1050 | 950 | 646 |
| P [barg] | 11.5 | 11.5 | 10.0 | 10.0 | 9.5 |
| Flow [Nm³/h] | 5000 | 5000 | 4994 | 4968 | 9962 |
| Composition | | | | | |
| [mole %] | | | | | |
| H2 | 69.2 | 69.2 | 45.1 | 45.6 | 45.3 |
| CO2 | 30.8 | 30.8 | 6.8 | 7.9 | 7.3 |
| N2 | 0.0 | 0.0 | 0.0 | 0.0 | 0.0 |
| CO | 0.0 | 0.0 | 24.0 | 22.8 | 23.4 |
| H2O | 0.0 | 0.0 | 24.1 | 23.4 | 23.8 |
| CH4 | 0.0 | 0.0 | 0.1 | 0.3 | 0.2 |

### Example 3

In another example, a combination of an e-RWGS and a HER is illustrated in Table 3, illustrating how HER can be the principle CO producing unit. In this case a primary feed of 10000 Nm³/h containing 69.2% H₂ and 30.8% is separated into a first and a second feed of respectively 45% and 55% of the total molar flow. The stream from the e-RWGS again produces a synthesis gas with a H₂/CO ratio of 1.88 by heating and converting the gas according to thermodynamics to 1050° C. The HER is operated with an outlet temperature of 905° C. (as given partly by the available temperatures from the heating gases) and receives 55% of the molar flow from the primary feed (i.e. 55% of the combined molar flow of the first and second feed). The first and the second product streams are mixed as used as heating source for the HER which cools the gas to 621° C., i.e. leaving 171° C. of driving force for the heat exchange. Overall, the combined synthesis gas has a H₂/CO ratio of 1.98, which is slightly higher than the comparative example. However, this is also done using only 637 kcal per Nm³ CO, which is 52% reduced duty compared to the comparative example. Specifically, the duty required for e-RWGS is 1.4 Gcal/h, while the duty transferred to the process side of the HER is 1.3 Gcal/h and the HER thereby constitutes 48% of the total transferred duty to process side across the two reactors. This duty split roughly reflects split in CO production, where 52% of the CO production is done in the HER.

The carbon activity for the CO reduction reaction of the combined (i.e. third) cooled product gas is 73.

TABLE 3

| Stream | 1 | 2 | 11 | 21 | 35 |
|---|---|---|---|---|---|
| T [° C.] | 450 | 450 | 1050 | 905 | 621 |
| P [barg] | 11.5 | 11.5 | 10.0 | 10.0 | 9.5 |
| Flow [Nm³/h] | 4500 | 5500 | 4495 | 5420 | 9915 |
| Composition | | | | | |
| [mole %] | | | | | |
| H2 | 69.2 | 69.2 | 45.1 | 45.4 | 45.2 |
| CO2 | 30.8 | 30.8 | 6.8 | 8.6 | 7.8 |
| N2 | 0.0 | 0.0 | 0.0 | 0.0 | 0.0 |
| CO | 0.0 | 0.0 | 24.0 | 21.9 | 22.8 |
| H2O | 0.0 | 0.0 | 24.1 | 23.4 | 23.7 |
| CH4 | 0.0 | 0.0 | 0.1 | 0.7 | 0.4 |

### Example 4

In another example, a combination of a e-RWGS and a HER is illustrated in Table 4, illustrating how a HER operation can be configured with very low driving force for metal dusting. In this case a primary feed of 10000 Nm³/h containing 69.2% H₂ and 30.8% is separated into a first and a second feed of respectively 60% and 40% of the total molar flow. The stream from the e-RWGS again produces a synthesis gas with a H₂/CO ratio of 1.88 by heating and converting the gas according to thermodynamics to 1050° C. The HER is operated with an outlet temperature of 915° C. (as given partly by the available temperatures from the heating gases) and receives 40% of the molar flow from the primary feed (i.e. 40% of the combined molar flow of the first and second feed). The first and the second product streams are mixed as used as heating source for the HER which cools the gas to 737° C. Overall, the combined synthesis gas has a H₂/CO ratio of 1.95, which is slightly higher than the comparative example. However, this is also done using only 832 kcal per Nm³ CO, which is 38% reduced duty compared to the comparative example. Specifically, the duty required for e-RWGS is 1.9 Gcal/h, while the duty transferred to the process side of the HER is 1.0 Gcal/h and the HER thereby constitutes 34% of the total transferred duty to process side across the two reactors. This duty split roughly reflects split in CO production, where 38% of the CO production is done in the HER.

In the current configuration of the HER, it is utilized that the first reaction zone (I) of the HER is exothermic, which gives a high temperature rise on the process side and consequently also a lower temperature for cooling of the heating gas. This control means that the carbon activity cannot increase further. These details are explicitly illustrated by the temperature and actual gas carbon activity profile of the gas in the heating side of the HER illustrated in FIG. 8. Here it can be seen that the carbon activity for the CO reduction reaction does not exceed 1.6.

TABLE 4

| Stream | 1 | 2 | 11 | 21 | 35 |
|---|---|---|---|---|---|
| T [° C.] | 450 | 450 | 1050 | 915 | 738 |
| P [barg] | 11.5 | 11.5 | 10.0 | 10.0 | 9.5 |
| Flow [Nm³/h] | 6000 | 4000 | 5993 | 3952 | 9945 |
| Composition | | | | | |
| [mole %] | | | | | |
| H2 | 69.2 | 69.2 | 45.1 | 45.5 | 45.2 |
| CO2 | 30.8 | 30.8 | 6.8 | 8.4 | 7.4 |
| N2 | 0.0 | 0.0 | 0.0 | 0.0 | 0.0 |
| CO | 0.0 | 0.0 | 24.0 | 22.1 | 23.2 |
| H2O | 0.0 | 0.0 | 24.1 | 23.4 | 23.8 |
| CH4 | 0.0 | 0.0 | 0.1 | 0.6 | 0.3 |

### Example 5

In another example, a combination of a e-RWGS and a HER is illustrated in Table 5, illustrating how this configuration can be used to produce synthesis gas suitable for methanol production with a high content of CO. In this case a primary feed of 10000 Nm³/h containing 75% H₂ and 25% CO₂ is separated into a first and a second feed of respectively 60% and 40% of the total molar flow. The stream from the e-RWGS produces a synthesis gas with a H₂/CO ratio of 2.6 by heating and converting the gas according to thermodynamics to 1050° C. The HER is operated with an outlet temperature of 930° C. (as given partly by the available temperatures from the heating gases) and receives 40% of the molar flow from the primary feed (i.e. 40% of the combined molar flow of the first and second feed). The first and the second product streams are mixed as used as heating source for the HER which cools the gas to 750° C. Overall, the combined synthesis gas has a H₂/CO ratio of 2.68 and a module of 2.0 suitable for methanol production. This is also done using 899 kcal per Nm³ CO. Specifically, the duty required for e-RWGS is 1.8 Gcal/h, while the duty transferred to the process side of the HER is 0.9 Gcal/h and the HER thereby constitutes 34% of the total transferred duty to process side across the two reactors. This duty split roughly reflects split in CO production, where 38% of the CO production is done in the HER.

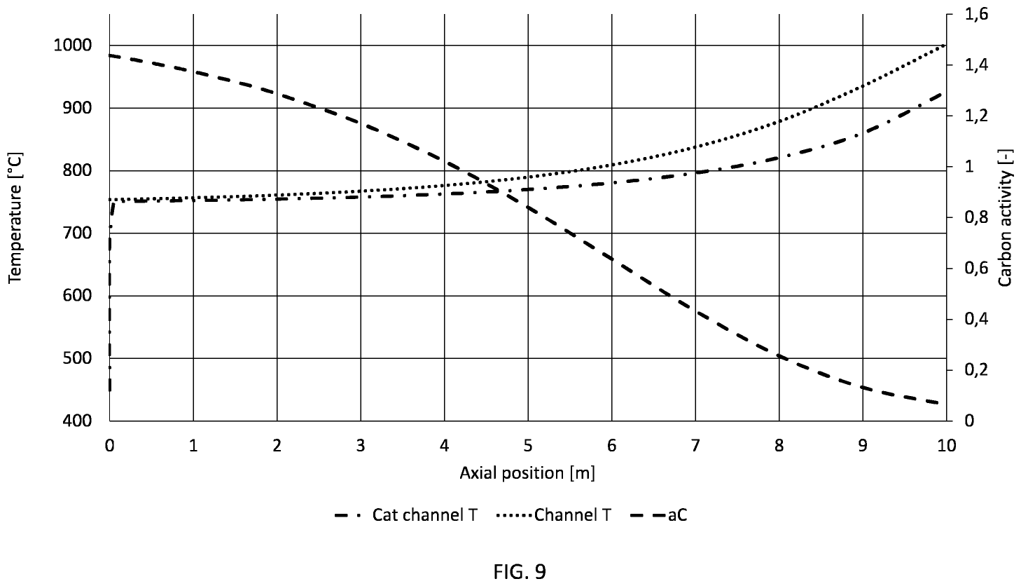

In the current configuration of the HER, it is utilized that the first reaction zone (1) of the HER is exothermic, which gives a high temperature rise on the process side and consequently also a lower temperature for cooling of the heating gas. This control means that the carbon activity cannot increase further. These details are explicitly illustrated by the temperature and actual gas carbon activity of the gas in the heating side of the HER in the given example illustrated in FIG. 9. Here it can be seen that the carbon activity for the CO reduction reaction does not exceed 1.5.

TABLE 5

| Stream | 1 | 2 | 11 | 21 | 35 |
|---|---|---|---|---|---|
| T [° C.] | 450 | 450 | 1050 | 930 | 750 |
| P [barg] | 11.5 | 11.5 | 10.0 | 10.0 | 9.5 |
| Flow [Nm³/h] | 6000 | 4000 | 5988 | 3941 | 9929 |
| Composition | | | | | |
| [mole %] | | | | | |
| H2 | 75.0 | 75.0 | 54.0 | 53.8 | 53.9 |
| CO2 | 25.0 | 25.0 | 4.2 | 5.3 | 4.7 |
| N2 | 0.0 | 0.0 | 0.0 | 0.0 | 0.0 |
| CO | 0.0 | 0.0 | 20.7 | 19.3 | 20.2 |
| H2O | 0.0 | 0.0 | 20.9 | 20.8 | 20.9 |
| CH4 | 0.0 | 0.0 | 0.1 | 0.7 | 0.4 |

### Example 6

In another example, a combination of a e-RWGS and a HER is illustrated in Table 5, illustrating how this configuration can be used to also process a primary feedstock containing methane. In this case a primary feed of 10000 Nm³/h containing 56.8% H₂, 22.7% CO₂, 11.4% CH₄, and 9.1% H₂O is separated into a first and a second feed of respectively 70% and 30% of the total molar flow. The stream from the e-RWGS produces a synthesis gas with a H₂/CO ratio of 2.37 by heating and converting the gas according to thermodynamics to 1050° C. The HER is operated with an outlet temperature of 912° C. (as given partly by the available temperatures from the heating gases) and receives 30% of the molar flow from the primary feed (i.e. 30% of the combined molar flow of the first and second feed). The first and the second product streams are mixed as used as heating source for the HER which cools the gas to 682° C. Overall, the combined synthesis gas has a H₂/CO ratio of 2.41. This is done using 1456 kcal per Nm³ CO, and part of the duty goes to the more endothermic reforming reaction. Specifically, the duty required for e-RWGS is 4.2 Gcal/h, while the duty transferred to the process side of the HER is 1.4 Gcal/h and the HER thereby constitutes 26% of the total transferred duty to process side across the two reactors. This duty split roughly reflects split in CO production, where 27% of the CO production is done in the HER.

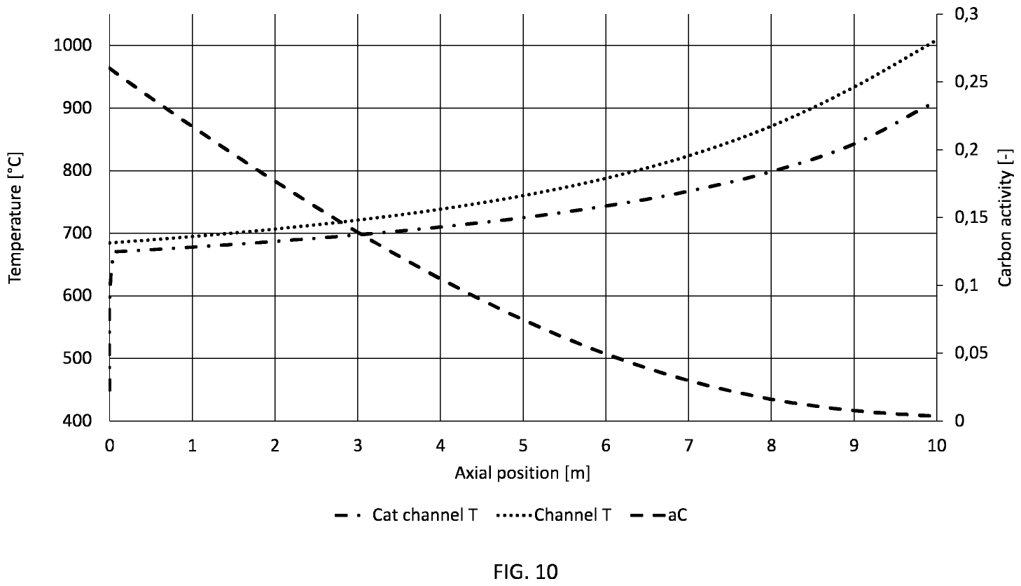

In the current configuration of the HER, it is utilized that the first reaction zone (I) of the HER is exothermic, which gives a high temperature rise on the process side and consequently also a lower temperature for cooling of the heating gas. This control means that the carbon activity cannot increase further. These details are explicitly illustrated by the temperature and actual gas carbon activity profile of the gas in the heating side of the HER in the given example illustrated in FIG. 10. Here it can see that the carbon activity for the CO reduction reaction does not exceed 0.3.

TABLE 5

| Stream | 1 | 2 | 11 | 21 | 35 |
|---|---|---|---|---|---|
| T [° C.] | 450 | 450 | 1050 | 912 | 682.53428 |
| P [barg] | 11.5 | 11.5 | 10.0 | 10.0 | 9.5 |
| Flow [Nm³/h] | 7000 | 3000 | 8553 | 3542 | 12095 |
| Composition | | | | | |
| [mole %] | | | | | |
| Hydrogen | 56.8 | 56.8 | 58.2 | 56.2 | 57.6 |
| Carbon Dioxide | 22.7 | 22.7 | 3.1 | 4.4 | 3.5 |
| Nitrogen | 0.0 | 0.0 | 0.0 | 0.0 | 0.0 |
| Methane | 11.4 | 11.4 | 0.2 | 2.0 | 0.7 |
| Water | 9.1 | 9.1 | 13.9 | 14.9 | 14.2 |
| Carbon Monoxide | 0.0 | 0.0 | 24.6 | 22.5 | 24.0 |

The present invention has been described with reference to a number of aspects and embodiments. These aspects and embodiments may be combined at will by the person skilled in the art while remaining within the scope of the patent claims.

1. A process for converting a first gas feed comprising CO₂ and H₂ to a synthesis gas stream, via a CO₂ shift reaction of said first gas feed in a heat exchange reactor, HER, said HER comprising
at least one process side and at least one heating side, wherein the process side of the HER comprises a process side inlet and a process side outlet,
wherein the process side of the HER comprises a first reaction zone disposed closest to the process side inlet, and
wherein process side of the HER comprises a second reaction zone disposed closest to the process side outlet,
wherein the heating side of the HER comprises a heating side inlet and—optionally—a heating side outlet,
said at least one process side and said at least one heating side, being arranged such that heat transfer from heating side to at least a part of said process side is possible,
said process comprising the steps of:
supplying the first gas feed to the process side of the HER via said process side inlet;
supplying a heating fluid to the heating side of the HER via said heating side inlet, and allowing heat transfer from said heating fluid to the process side of the HER;
carrying out an overall exothermic reaction of said first gas feed in the first reaction zone, wherein the overall exothermic reaction comprises at least the following reactions, which have a net progress from left to right: 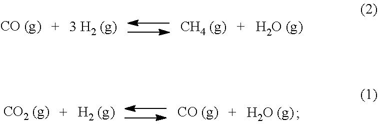
carrying out an overall endothermic reaction of gas from said first reaction zone in the second reaction zone, wherein the overall endothermic reaction comprises at least the following reactions, which have a net progress from left to right: 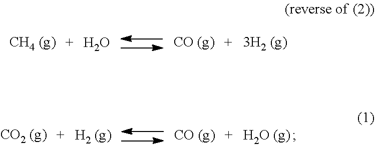
outletting the synthesis gas stream from the process side via the process side outlet; optionally in admixture with a cooled fluid, and
optionally outletting a cooled fluid from said heating side, via the heating side outlet.

2. The process according to claim 1, wherein the temperature of the gas in the first reaction zone is between 300-800° C.

3. The process according to claim 1, wherein the temperature of the gas in the second reaction zone is between 600-1200° C.

4. The process according to claim 1, wherein the synthesis gas stream and the cooled fluid are combined to provide a third product stream.

5. The process according to claim 1, wherein the heating fluid and at least a portion of the synthesis gas stream leaving the second reaction zone are combined internally in the HER and recycled as at least a part of the heating fluid.

6. The process according to claim 1, wherein the process conditions are adjusted to provide a temperature of the synthesis gas stream and/or the cooled fluid, and/or the third product stream at the respective outlet of the HER which is higher than the critical limit for metal dusting.

7. The process according to claim 1, wherein the cooled exit temperature of the synthesis gas stream and/or the cooled fluid and/or the third product stream is 500° C. or higher.

8. The process according to claim 1, wherein the synthesis gas stream and/or the cooled fluid and/or the third product stream at said cooled exit temperature has a CO reduction reaction actual gas carbon activity lower than 100.

9. The process according to claim 1, wherein the H₂/CO ratio of the synthesis gas stream and/or the cooled fluid and/or the third product stream is in the range from 0.5 to 3.0.

10. The process according to claim 1, wherein the (H₂—CO₂)/(CO+CO₂) ratio of the synthesis gas stream and/or the cooled fluid and/or the third product stream is in the range from 1.5 to 2.5.

11. The process according to claim 1, wherein the ratio between H₂ and CO₂ may be between 1-5.

12. The process according to claim 1, wherein the molar ratio of CH₄/CO₂ in the first feed is less than 0.5.

13. The process according to claim 1, wherein the first gas feed additionally comprises methane.

14. The process according to claim 1, wherein the heating fluid is provided from an electrical RWGS (e-RWGS) reactor, a fired RWGS reactor or an autothermal RWGS reactor.

15. The process according to claim 1, wherein the heating fluid comprises CO₂ and H₂.

16. A heat exchange reactor (HER), for converting a first gas feed comprising CO₂ and H₂ to a synthesis gas stream, via a CO₂ shift reaction of said first gas feed, said HER comprising:
at least one process side and at least one heating side, wherein the process side of the HER comprises a process side inlet and a process side outlet,
said process side inlet being arranged to supply said first gas feed comprising CO₂ and H₂ to said process side,
said process side outlet being arranged to output said synthesis gas stream from said process side, optionally in admixture with a cooled fluid,
wherein the process side of the HER comprises a first reaction zone disposed closest to the process side inlet, and
wherein process side of the HER comprises a second reaction zone disposed closest to the process side outlet,
wherein the first reaction zone is arranged to carry out an overall exothermic reaction of said first gas feed, wherein the overall exothermic reaction comprises at least the following reactions, which have a net progress from left to right: 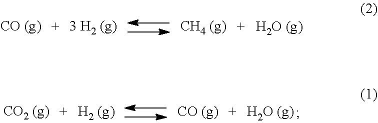
wherein the second reaction zone is arranged to carry out an overall endothermic reaction of gas from said first reaction zone, wherein the overall endothermic reaction comprises at least the following reactions, which have a net progress from left to right: 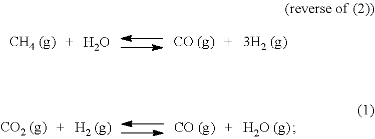
wherein the heating side of the HER comprises a heating side inlet and—optionally—a heating side outlet,
said heating side inlet being arranged to supply a heating fluid to said heating side,
optionally, wherein said heating side outlet being arranged to output a cooled fluid from said heating side,
said at least one process side and said at least one heating side, being arranged such that heat transfer from heating side to at least a part of process side is possible.

17. The HER according to claim 16, wherein the process side of the HER has a total length extending from the process side inlet to the process side outlet, and wherein the first reaction zone has an extension of less than 50% of the total length of the process side of the HER.

18. The HER according to claim 16, wherein a first catalyst is located at least in the first reaction zone of the HER.

19. The HER according to claim 16, wherein at least an end section of the process side of the first reaction zone, which is located closest to the process side inlet of the HER, and which has an extension of up to 25% of the total extension of the process side of the first reaction zone in the direction from the process side inlet towards the process side outlet, is not directly in contact with the heating side of the HER, so that this end section of the first reaction zone is primarily heated by the adiabatic temperature rise caused by the exothermic reaction in the first reaction zone.

20. The HER according to claim 16, wherein the HER is a bayonet-type HER.

21. The HER according to claim 16, wherein the HER has at least two process sides.

22. The HER according to claim 16, wherein the HER has at least two heating sides.
